(19) United States
(12) Patent Application Publication
(10) Pub. No.: US 2025/0231383 A1
(43) Pub. Date: Jul. 17, 2025

(54) LENS OPTICAL SYSTEM WITH HIGH RESOLUTION

(71) Applicant: SAMYANG OPTICS CO., LTD, Changwon-si (KR)

(72) Inventor: Ju Yeon JO, Changwon-si (KR)

(73) Assignee: SAMYANG OPTICS CO., LTD, Changwon-si (KR)

(21) Appl. No.: 18/664,519

(22) Filed: May 15, 2024

(30) Foreign Application Priority Data
Jan. 11, 2024 (KR) 10-2024-0004999

(51) Int. Cl. G02B 15/14; G02B 13/02; G02B 13/06; G02B 13/18

(52) U.S. Cl. CPC G02B 15/1461; G02B 13/02; G02B 13/06; G02B 13/18

(57) ABSTRACT

A lens optical system includes, a first lens group closest to an object side with a positive refractive power, a second lens group located after the first lens group with a negative refractive power, a third lens group located after the second lens group, consisting of no more than three lenses and having either a positive or negative refractive power, and a rear lens group next to the third lens group and an aperture, which has a positive refraction power as a whole. The rear lens group includes, a fifth lens group moving along the optical axis toward the image side when its focusing from an object at an infinite distance to the object at a near distance, a fourth lens group disposed between the aperture and the fifth lens group, and a sixth lens group disposed between the fifth lens group and an image plane.

### CROSS-REFERENCE TO RELATED APPLICATION

This application claims priority from Korean Patent Application No. 10-2024-0004999 filed on Jan. 11, 2024, in the Korean Intellectual Property Office, and all the benefits accruing therefrom under 35 U.S.C. 119, the contents of which in its entirety are herein incorporated by reference.

### BACKGROUND

### 1. Technical Field

The present invention relates to a lens optical system operating in a wide-angle range and a telephoto range with a zoom ratio of 4.3× and high resolution.

### 2. Description of the Related Art

In recent years, the demands on zoom lens optics used in imaging devices have increased significantly. These demands extend beyond performance criteria, such as achieving a high zoom ratio and high brightness, to include considerations of portability, such as lightweight and compact design. Achieving a high zoom ratio often involves configuring lens optics as a positive lead type, where the first lens group (positive group) moves to the opposite side of the image plane during changes in the angle of view. However, this configuration leads to challenges, as increasing the zoom ratio results in a longer overall length at the telephoto stage, and enhancing brightness leads to larger apertures in each lens, contributing to a bulkier and heavier product.

The pursuit of a high zoom ratio and brightness necessitates specifications that enhance the refractive power of the lens optical system, making it difficult to reduce the weight of the system. To address the requirements of conventional zoom lens optics, additional elements for lightweighting are crucial, along with a proper distribution of refractive power.

Reducing the weight of lens optics can be achieved by appropriately limiting the specific gravity of the lens material. Glass materials used in optical lenses have varying specific gravities, ranging from FC5 (Hoya corporation) with a specific gravity of 2.5 to E-FDS3 (Hoya corporation) with a specific gravity of 5.6. In general, dense materials such as FDS and BaCD and tantalum materials such as TaFD, TaF, and TaC are known to have a high proportion of weight. In particular, tantalum-based materials have a high refractive power, which is advantageous for simplifying the lens optics and correcting Petzval curvature aberrations. For these reasons, when selecting materials for the lens optical system, the proportion of lenses that enable minimizing aberrations while achieving lightweight design should be appropriately considered.

When capturing a subject, the image position on the image sensor changes based on the subject's position, requiring compensation for optimal image quality. Focusing, the process of adjusting the focus position is necessary, and optical performance should be maintained across a broader range of distances including far, near and middle subject distances. Conventional interchangeable lenses employ various focusing methods, such as a front group focusing, a whole group focusing, a rear group focusing, an internal focusing in which only the inside lens groups are moved, and a floating focusing in which two or more lens groups simultaneously are moved to perform focusing. While the floating focusing is advantageous in aberration correction, it also causes complicated internal configuration and heavy weight of the camera.

The conventional lens optical system described in JP 2019-53122A achieves a zoom ratio of 4.1× and a brightness of F4.12 at both the wide-angle range and telephoto range. Despite its high zoom ratio and a single focus group, the system has a low brightness at F4.12, necessitating a high shutter speed.

Therefore, there is a growing demand to develop a lens optical system that guarantees stable performance over a broader zoom range from wide-angle to telephoto, by achieving a high zoom ratio and brightness, while concurrently reducing the weight and size of the lens optical system.

### SUMMARY

Aspects of the present invention provide a lens optical system for photographing, in which uniform resolution distribution throughout the lens optic system is achieved by restricting the focus lens group composition to a single lens with one element and limiting the number of lenses containing tantalum-based materials to no more than two elements.

Aspects of the present invention also provide a lens optical system for photographing, which has a high zoom ratio and high brightness while keeping the system light in weight and relatively short in length.

However, aspects of the present invention are not restricted to those set forth herein. The above and other aspects will become more apparent to one of ordinary skill in the art to which the disclosure pertains by referencing the detailed description of the present invention given below.

According to an aspect of an exemplary embodiment, there is provided a lens optical system, comprising: a first lens group closest to an object side with a positive refractive power; a second lens group located after the first lens group with a negative refractive power; a third lens group located after the second lens group, consisting of no more than three lenses and having either a positive or negative refractive power; and a rear lens group next to the third lens group and an aperture, which consists of a multiple lens groups and has a positive refraction power as a whole,
wherein, when zooming from the wide-angle stage to the telephoto stage, the first lens group is moved toward the object side and the second lens group is moved toward an image side, and wherein the rear lens group includes: a fifth lens group moving along the optical axis toward the image side when its focusing from an object at an infinite distance to the object at a near distance; a fourth lens group disposed between the aperture and the fifth lens group; and a sixth lens group disposed between the fifth lens group and an image plane.

The rear lens group consists of no more than three lenses with a material specific gravity of at least 4.0 and satisfies the condition:

$$0.52 \leq \frac{{L}_{Gm}}{{L}_{f}} \leq 0.65 ,$$

where the L_{f} is the distance from the lens closest to the object side of the fourth lens group to the last lens of the sixth lens group at the wide-angle stage of the lens optical system, and the L_{Gm} is the distance from the lens closest to the object side of the fourth lens group to the first lens of the fifth lens group at the wide-angle stage of the lens optical system.

The lens optical system satisfies the condition: Vd_{G-avg}≥70, where the Vd_{G-avg} is the average of the dispersion constants of the lenses with the maximum dispersion constant in each of the first lens group, second lens group, third lens group, and rear lens group.

The lens optical system satisfies the condition:

$$4.6 \leq \frac{{LW}_{Gm}}{{L}_{d}} \leq 13.2 ,$$

where the L_{d} is the position difference in the direction of the optical axis at the wide-angle stage of the lens optical system, between the position of the fifth lens group when the object distance is infinity and the position of the fifth lens group when the object distance is the closest distance, and

The LW_{Gm} is the distance from the first lens of the fourth lens group to the first lens of the fifth lens group at the wide-angle stage of the lens optical system when the object distance is infinity.

The lens optical system satisfies the condition:

$$\frac{1}{{n}_{a}} \geq 0.59 ,$$

where the nₐ is the reciprocal of the average of the refractive indices for all lenses used in the lens optical system.

The lens of the sixth lens group closest to the image side is a convex meniscus lens convex oriented toward the image side.

The lens optical system comprises three or fewer aspherical lenses.

The fourth lens group comprises a junction lens formed by combining three lenses together.

The second lens group or the rear lens group comprises a single hybrid aspherical lens.

According to the lens optical system presented in the present invention, adjusting the focus involves the movement of a single lens within the system. This ensures that the overall length of the optical system remains constant throughout the focusing process. This design not only enhances user convenience but also contributes to improved environmental performance, including dustproof and splashproof features.

### BRIEF DESCRIPTION OF THE DRAWINGS

The above and other aspects and features of the present invention will become more apparent by describing in detail exemplary embodiments thereof with reference to the attached drawings, in which:

FIG. 1 is a view showing an optical layout showing an arrangement of lens components in a lens optical system at a wide-angle stage, according to a first embodiment of the present invention.

FIG. 2 is a view showing an optical layout showing an arrangement of lens components in a lens optical system at a telephoto stage, according to a first embodiment of the present invention.

FIG. 3 is a view showing a ray fan diagram of the lens optical system at a wide-angle stage, according to the first embodiment of the present invention.

FIG. 4 is a view showing a ray fan diagram of the lens optical system at a telephoto stage, according to the first embodiment of the present invention.

FIG. 5 is a view showing an optical layout showing an arrangement of lens components in a lens optical system at a wide-angle stage, according to a second embodiment of the present invention.

FIG. 6 is a view showing an optical layout showing an arrangement of lens components in a lens optical system at a telephoto stage, according to a second embodiment of the present invention.

FIG. 7 is a view showing a ray fan diagram of the lens optical system at a wide-angle stage, according to the second embodiment of the present invention.

FIG. 8 is a view showing a ray fan diagram of the lens optical system at a telephoto stage, according to the second embodiment of the present invention.

FIG. 9 is a view showing an optical layout showing an arrangement of lens components in a lens optical system at a wide-angle stage, according to a third embodiment of the present invention.

FIG. 10 is a view showing an optical layout showing an arrangement of lens components in a lens optical system at a telephoto stage, according to a third embodiment of the present invention.

FIG. 11 is a view showing a ray fan diagram of the lens optical system at a wide-angle stage, according to the third embodiment of the present invention.

FIG. 12 is a view showing a ray fan diagram of the lens optical system at a telephoto stage, according to the third embodiment of the present invention.

FIG. 13 is a view showing an optical layout showing an arrangement of lens components in a lens optical system at a wide-angle stage, according to a fourth embodiment of the present invention.

FIG. 14 is a view showing an optical layout showing an arrangement of lens components in a lens optical system at a telephoto stage, according to a fourth embodiment of the present invention.

FIG. 15 is a view showing a ray fan diagram of the lens optical system at a wide-angle stage, according to the fourth embodiment of the present invention.

FIG. 16 is a view showing a ray fan diagram of the lens optical system at a telephoto stage, according to the fourth embodiment of the present invention.

FIG. 17 shows a photographing apparatus having the lens optical system according to the embodiments of the present invention.

### DETAILED DESCRIPTION OF THE EMBODIMENTS

Advantages and features of the disclosure and methods to achieve them will become apparent from the descriptions of exemplary embodiments herein below with reference to the accompanying drawings. However, the inventive concept is not limited to exemplary embodiments disclosed herein but may be implemented in various ways. The exemplary embodiments are provided for making the disclosure of the inventive concept thorough and for fully conveying the scope of the inventive concept to those skilled in the art. It is to be noted that the scope of the disclosure is defined only by the claims. Like reference numerals denote like elements throughout the descriptions.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for illustrating the embodiments rather than limiting the present disclosure. As used herein, the singular forms are intended to include plural forms as well, unless the context clearly indicates otherwise. Throughout this specification, the word “comprise” and variations such as “comprises” or “comprising,” will be understood to imply the inclusion of stated elements but not the exclusion of any other elements.

The lens optical system in accordance with the invention delivers high resolving power within a range spanning an angle of view from approximately 63 degrees at the wide-angle stage to 16 degrees at the telephoto stage. Notably, when focusing is necessary to compensate for changes in the image point based on the subject's position, the lens optical system employs an internal focusing method. This method serves to reduce the overall length of the lens optical system, ensuring a fixed length during focusing and incorporating a lightweight focusing lens group for achieving rapid auto-focusing. Additionally, the system is characterized by its lightweight design, achieved by judiciously limiting the use of high refractive power and high specific gravity lenses, thereby preserving high-resolution capabilities.

Hereinafter, exemplary embodiments of the present disclosure will be described in detail with reference to the accompanying drawings.

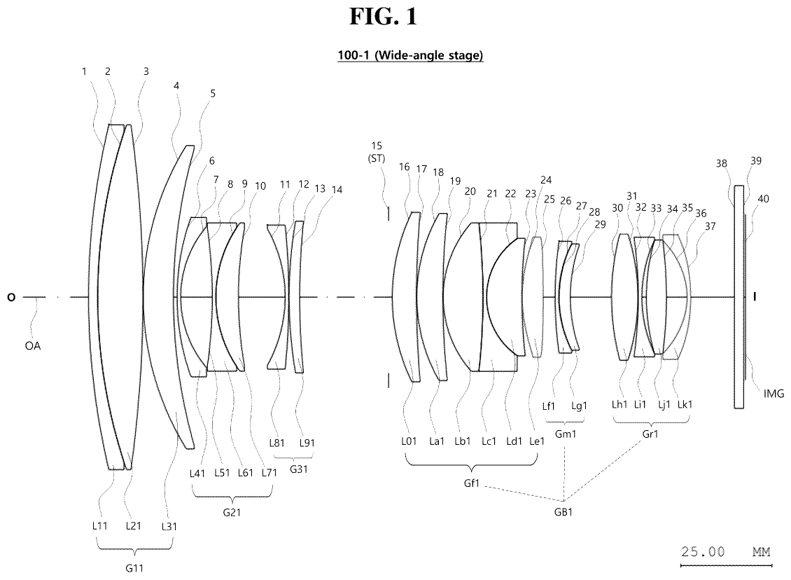

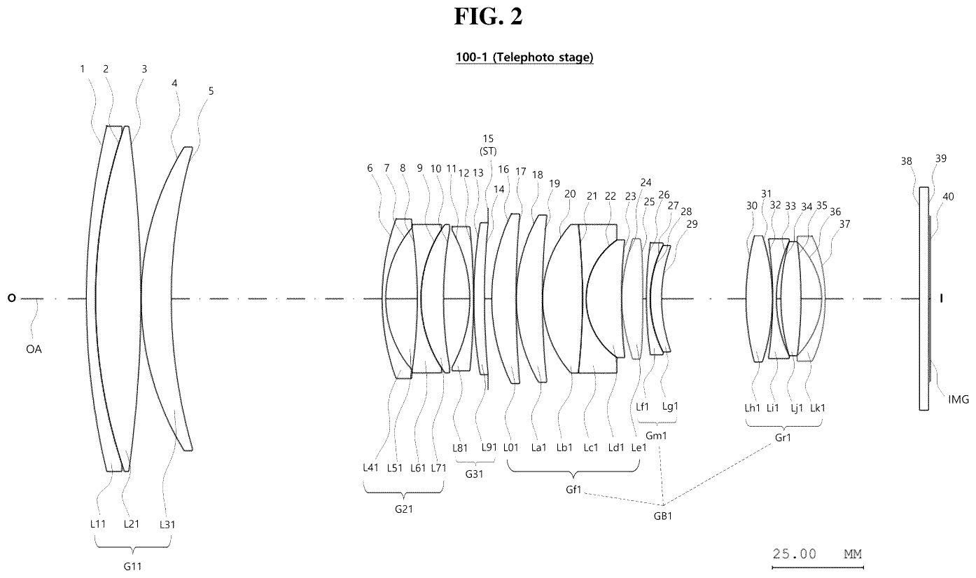

FIG. 1 is a view showing an optical layout showing an arrangement of lens components in a lens optical system 100-1 at a wide-angle stage, according to a first embodiment of the present invention, and FIG. 2 is a view showing an optical layout showing an arrangement of lens components in a lens optical system 100-1 at a telephoto stage, according to a first embodiment of the present invention.

In FIGS. 1 and 2, numbers 1 to 40 designate the identification numbers for the lens surfaces (with two surfaces for each lens). In addition, L11 to Lk1 represent the lens identification numbers, while G11 to Gr1 indicate the identification symbols for the lens groups, respectively. Furthermore, the term “image side (I)” denotes the direction where the image plane (IMG) is located, representing the conjugate image. Conversely, the term “object side (O)” points to the direction where the object is situated. The image plane (IMG) may encompass various elements such as an imaging element plane or an image sensor plane. For instance, the image sensor can include technologies like a complementary metal oxide semiconductor (CMOS) image sensor or a charge-coupled device (CCD). Additionally, the image sensor serves as a component capable of converting the subject's image into an electrical image signal.

Referring to FIGS. 1 and 2, the lens optical system 100-1 includes a front-end lens group consisting of the first lens group G11, second lens group G12, and third lens group G31, arranged sequentially from the object side (O) to the image side (I). It also comprises a rear lens group consisting of the Gf lens group Gf1, Gm lens group Gm1, and Gr lens group Gr1.

Throughout this description, the three lens groups forming the posterior lens group are denoted as Gf lens group (Gfx), Gm lens group (Gmx), and Gr lens group (Grx) for clarity (where “x” represents the order of embodiments), but they can also be referred to as the fourth, fifth, and sixth lens groups, respectively.

The first lens group G11 includes one double-junction lens L11, L21 and one meniscus lens element L31 from the object side (O), having a synthetic focal length of positive refractive power. This design enables subsequent lens groups, including the second lens group (G21) and those following it, to have smaller apertures, contributing to the lightweighting of the lens optics.

When adjusting the magnification of the lens optical system, the first lens group G11 moves along the optical axis OA towards the object side O. This movement is necessary as the focal point inside the lens optical system must move further towards the object side O than the position of the conventional wide-angle stage, depending on the focal length of the telephoto stage (refer to FIG. 2). Simultaneously, the second lens group G21, featuring a meniscus lens L41 with strong negative refractive power convex to the object side O, undergoes the main magnification change by moving upwardly (I) along the optical axis OA during magnification adjustment. The third lens group G31 acts as a relay lens between the second lens group G21 and the rear lens group GB1.

The rear lens group GB1, positioned after the aperture ST with respect to the object side O, consists of multiple lens groups Gf1, Gm1, Gr1, wherein the spacing between neighboring lens groups changes during zooming. The entire rear lens group GB1 exhibits strong positive refractive power.

Specifically, the rear-end lens group GB1 comprises a Gm lens group (Gm1: fifth lens group) moving upwardly (I) along the optical axis (OA) during focusing from an object at infinite distance to a nearby object. It also includes a Gf lens group (Gf1: fourth lens group) positioned between the aperture (ST) and the Gm lens group (Gm1), and a Gr lens group (Gr1: sixth lens group) positioned between the Gm lens group (Gm1) and the imaging plane (IMG).

Detailed design data for the lenses in the lens optical system 100-1, according to this first embodiment, is presented in Table 1. The design data includes the lens's radius of curvature (“Radius”), thickness (“Thick”), refractive power (“nd”), Abbe number (“Vd”), and the lens group to which it belongs. The units for Radius and Thickness are in millimeters.

Additionally, each lens surface's object is numbered (1 to 40 in FIGS. 1 and 2), representing the a surface of all lenses arranged in phase (I) from the object (O).

TABLE 1

| Surface | Radius | Thickness | nd | vd | Lens group |
|---|---|---|---|---|---|
| Object | | D0 | | | |
| 1 | 195.8346 | 2.5 | 1.8052 | 25.46 | Group 1 |
| 2 | 139.9438 | 12.402 | 1.497 | 81.61 | |
| 3 | −328.0816 | 0.1 | | | |
| 4 | 76.5105 | 8.2471 | 1.497 | 81.61 | |
| 5 | 142.4628 | D5 | | | |
| 6 | 62.1406 | 1 | 1.7234 | 37.99 | Group 2 |
| 7 | 29.0041 | 8.6389 | | | |
| 8 | −131.185 | 1 | 1.497 | 81.61 | |
| 9 | 33.5412 | 6.1868 | 1.8467 | 23.78 | |
| 10 | 103.7085 | D10 | | | |
| 11 | −37.3368 | 1 | 1.7015 | 41.15 | Group 3 |
| 12 | −193.6095 | 0.1 | | | |
| 13 | 118.7942 | 2.9201 | 1.5935 | 67.00 | |
| 14 | 203.0209 | D14 | | | |
| 15 | inf | 1 | | | ST (Stop) |
| 16 | 50.994 | 6.6336 | 1.8545 | 25.15 | Group Gf |
| 17 | 251.3159 | 0.1 | | | |
| 18 | 44.5238 | 7.1121 | 1.5935 | 67.00 | |
| 19 | 202.226 | 0.1 | | | |
| 20 | 29.8086 | 10.9029 | 1.497 | 81.61 | |
| 21 | −178.7755 | 1 | 2.001 | 29.13 | |
| 22 | 19 | 9.6586 | 1.497 | 81.607 | |
| 23 | 136.3642 | 0.1 | | | |
| 24* | 37.7377 | 5.7354 | 1.7729 | 49.5186 | |
| 25* | −498.0468 | D25 | | | |
| 26 | 104.581 | 1 | 1.7705 | 29.7352 | Group Gm |
| 27 | 30.5913 | 0.1221 | | | |
| 28 | 31.6014 | 3.0601 | 1.497 | 81.6074 | |
| 29 | 40.9656 | D29 | | | |
| 30 | 64.3456 | 7.2136 | 1.9229 | 20.88 | Group Gr |
| 31 | −54.0119 | 0.1 | | | |
| 32 | −111.1966 | 1 | 2.001 | 29.1343 | |
| 33 | 35.4584 | 1.2353 | | | |
| 34 | 53.1352 | 5.5015 | 1.8052 | 25.456 | |
| 35 | −114.6477 | 5.6474 | | | |
| 36* | −18.7755 | 1 | 1.6935 | 53.185 | |
| 37* | −46.4477 | D37 | | | |
| 38 | Inf | 2.5 | 1.5168 | 64.1973 | IMG |
| 39 | Inf | 0.503 | | | |
| 40 | inf | −0.003 | | | |

Meanwhile, in the lens optical system 100-1, according to the first embodiment depicted in FIGS. 1 and 2, the lens Le1, corresponding to object numbers 24 and 25, and the lens Lk1, corresponding to object numbers 36 and 37, are both aspherical lenses. An aspherical lens is characterized by a varying radius of curvature, dependent on the position offset from the center. The aspherical shape of such a lens can be described by the following Equation 1, where the z-axis represents the direction of the optical axis (OA), the y-axis represents the direction perpendicular to the optical axis, and the positive quantity denotes the direction of the light ray.

$$z = \frac{{cr}^{2}}{1 + \sqrt{1 - ( 1 + K ) {c}^{2} {r}^{2}}} + {Ar}^{4} + {Br}^{6} + {Cr}^{8} + {Dr}^{10} + {Er}^{12} \qquad [ Equation 1 ]$$

Here, Z is the distance from the apex of the lens in the direction of the optical axis, r is the distance perpendicular to the optical axis (OA), K is the conic constant, and A, B, C, D and E represent aspheric coefficients. The parameter c is the reciprocal of the radius of curvature at the apex of the lens (1/R).

Specific data regarding the aspheric coefficients for the surfaces of the mentioned aspherical lenses are presented in Table 2.

TABLE 2

| ASP | 24* | 25* | 36* | 37* |
|---|---|---|---|---|
| K | 9.8794730 × E−01 | −1 | −47515740 × E−01 | 8.9969920 × E−01 |
| A | −9.6590921 × E−06 | −9.3419226 × E−07 | 8.0563590 × E−06 | −1.0816488 × E−06 |
| B | −9.7523982 × E−10 | −5.8668277 × E−09 | 6.4199182 × E−10 | −6.7378756 × E−09 |
| C | −8.2690424 × E−11 | −6.5044166 × E−11 | −1.4825396 × E−10 | −5.6432408 × E−11 |
| D | 3.8917216 × E−13 | 2.5863148 × E−13 | 3.3443981 × E−13 | 1.4926974 × E−13 |
| E | −1.0258070 × E−15 | −8.5514063 × E−16 | 0 | 0 |

Moreover, the zoom data for the lens optical system 100-1 in the first embodiment, considering distances from phase I at infinity and at the closest distance (MOD), is presented in Table 3. In this table, EFL denotes the Effective Focal Length, and BFL (in Air) signifies the distance from the last face of the lens optics to the acquisition element when no filter is positioned in front of the acquisition element. Additionally, Fno indicates the F number, providing insight into the brightness of the lens optics, while FOV represents the size of the area visible to the acquisition element as the field of view. Furthermore, OAL denotes the overall length of the lens optics, measuring the distance from the lens closest to the object side (O) of the lens optics to the imaging plane (IMG). Lastly, D0 to D37 represent the variable distances within the lens optic system 100-1.

TABLE 3
Zoom data Zoom ratio: 3.9

| | Infinity | | | MOD | | |
|---|---|---|---|---|---|---|
| Config | Wide | Middle | Tele | Wide | Middle | Tele |
| EFL | 50 | 90 | 195 | | | |
| BFE | 14.157 | 23.583 | 27.953 | | | |
| (in Air) | | | | | | |
| Fno | 2 | 2.43 | 2.82 | | | |
| FOV | 46.8 | 26.6 | 12.5 | | | |
| OAL | 164.986 | 182.18797 | 202.33985 | | | |
| β | — | — | — | 0.238 | 0.223 | 0.246 |
| D0 | inf | inf | Inf | 150.001 | 293.372 | 618.849 |
| D5 | 1.000 | 26.750 | 57.725 | — | — | — |
| D10 | 12.772 | 13.647 | 7.188 | — | — | — |
| D14 | 24.248 | 13.808 | 1.000 | — | — | — |
| D25 | 3.266 | 2.941 | 1.000 | 13.120 | 14.433 | 22.762 |
| D29 | 11.283 | 12.725 | 23.109 | 1.429 | 1.232 | 1.347 |
| D37 | 12.011 | 21.437 | 25.807 | — | — | — |

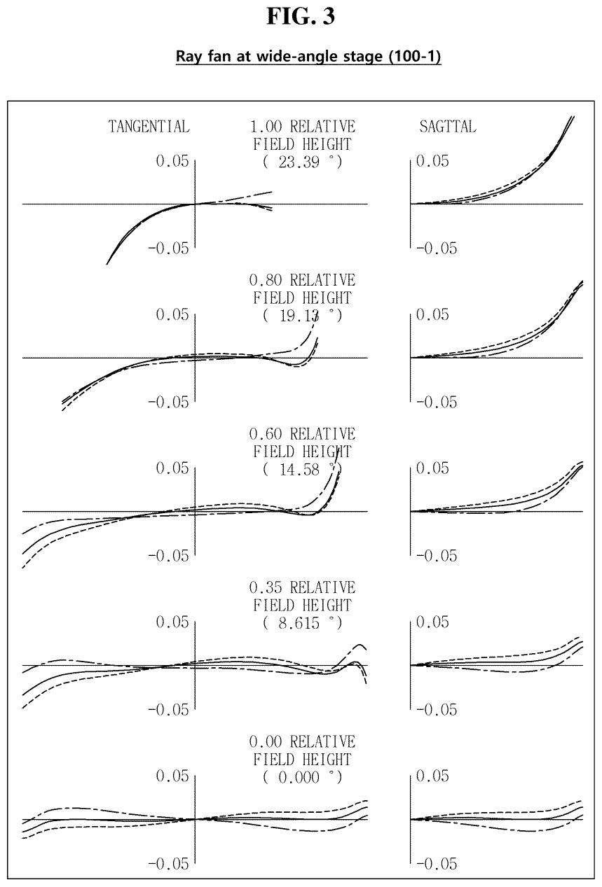

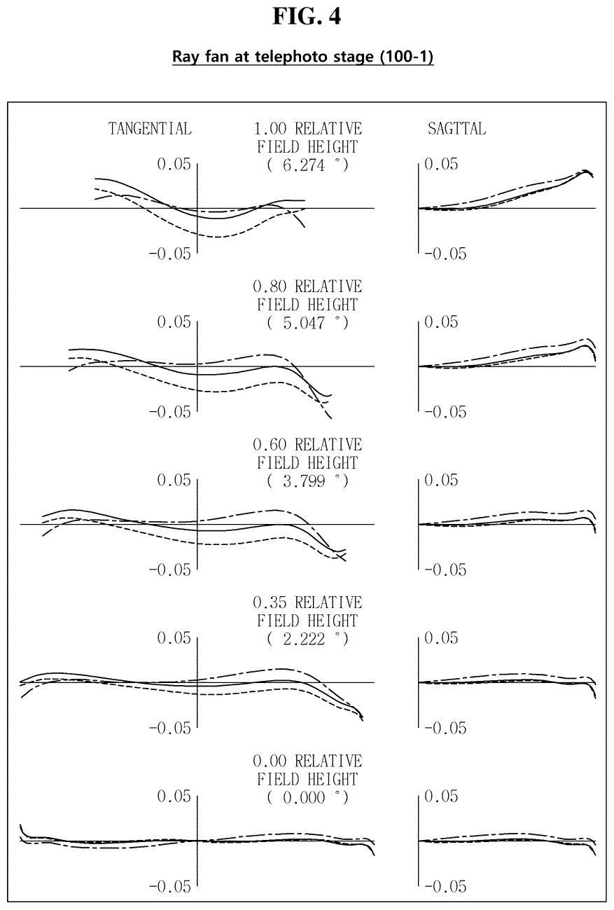

FIG. 3 is a view showing a ray fan diagram of the lens optical system 100-1 at a wide-angle stage, according to the first embodiment of the present invention, and FIG. 4 is a view showing a ray fan diagram of the lens optical system 100-1 at a telephoto stage, according to the first embodiment of the present invention.

Here, a dotted line denotes a 656.2725 NM wavelength (C-line), a solid line denotes a 587.5618 NM wavelength (d-line), and a dashed line denotes a ray fan (unit: mm) for a 486.1327 NM wavelength (F-line).

These ray fans are plotted as a ray fan graph for the respective Tangential and Sagittal planes when the relative field heights are 0 F, 0.35 F, 0.60 F, 0.80 F and 1.00 F.

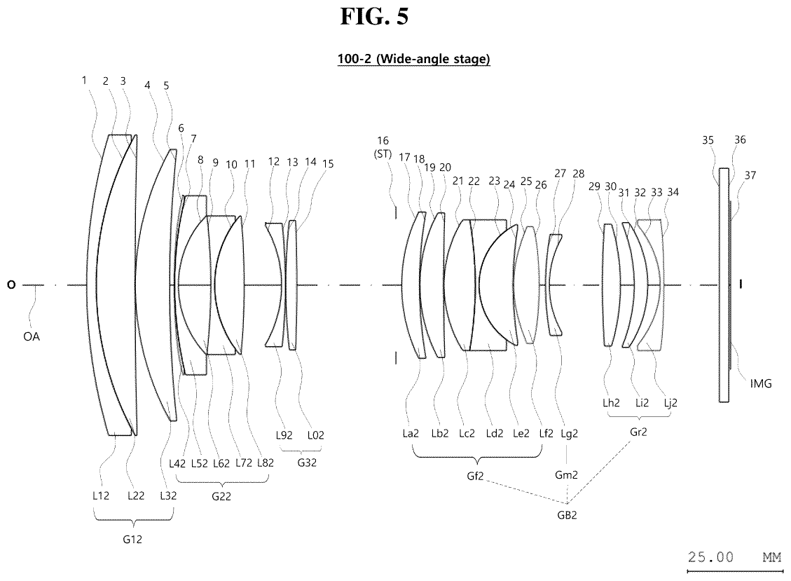

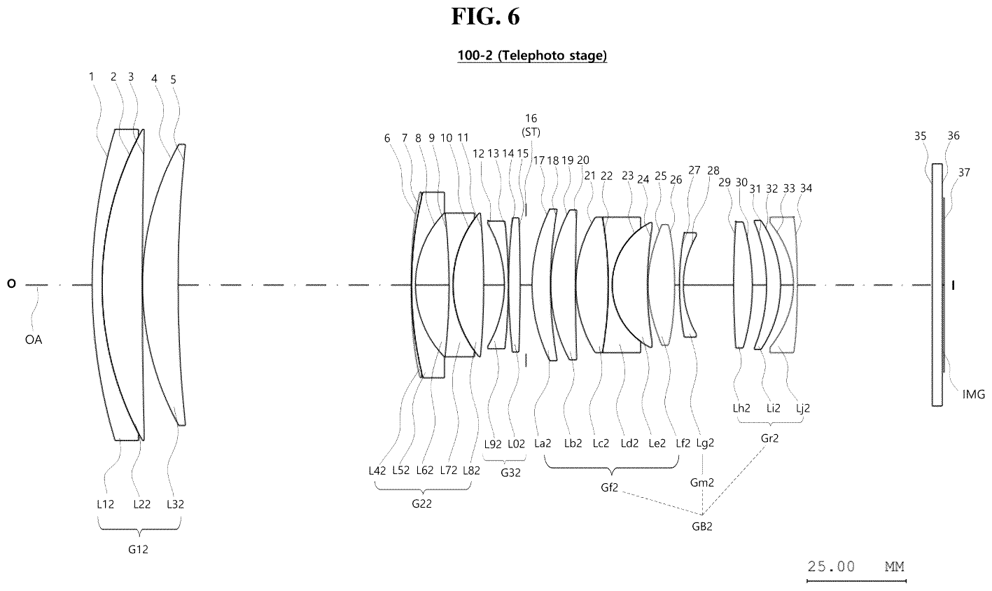

FIG. 5 illustrates an optical layout depicting the arrangement of lens components at a wide-angle stage configuration of a lens optical system 100-2, according to the second embodiment of the present invention, and FIG. 6 illustrates an optical layout showing the arrangement of lens components at a telephoto stage configuration of the same lens optical system 100-2.

In both figures, numbers 1 to 37 indicate identification numbers for a lens surface (with two surfaces for one lens), L12 to Lj2 represent lens identification numbers, and G12 to Gr2 represent identification symbols for groups of lenses, respectively.

Referring to FIGS. 5 and 6, the lens optical system 100-2 comprises a front-end lens group consisting of the first lens group G12, second lens group G22, and third lens group G32, arranged sequentially from the object side O to the image side I. Additionally, it includes a rear-end lens group comprising the Gf lens group Gf2, Gm lens group Gm2, and Gr lens group Gr2.

The first lens group G12 includes one double-junction lens element (L12, L22) and one meniscus lens element L32 from the object side O, with a composite focal length having positive refractive power. This design facilitates subsequent lens groups, including the second lens group (G22) and those following it, to have smaller apertures, contributing to the lightweighting of the lens optics. During changes in magnification, the first lens group G12 moves towards the object side O along the optical axis OA, necessitated by the focal point inside the lens optical system needing to move further towards the object side O than the position of the conventional wide-angle stage, depending on the focal length of the telephoto stage (refer to FIG. 6). Simultaneously, the second lens group G22, featuring a meniscus lens L52 with strong negative refractive power convex to the object side O, moves towards the image side I along the optical axis OA during magnification changes, executing the primary magnification change action. The third lens group G32 serves as a relay lens between the second lens group G22 and the rear-end lens group GB2.

The rear-end lens group GB2, positioned after the aperture ST concerning the object side O, consists of multiple lens groups Gf2, Gm2, Gr2, wherein the spacing between neighboring lens groups changes during zooming. The entire rear-end lens group GB2 exhibits strong positive refractive power.

Specifically, the rear-end lens group GB2 includes a Gm lens group (Gm2: fifth lens group) moving upwardly (I) along the optical axis (OA) during focusing from an object at an infinite distance to a nearby object. It also comprises a Gf lens group (Gf2: fourth lens group) positioned between the aperture (ST) and the Gm lens group (Gm2), and a Gr lens group (Gr2: sixth lens group) positioned between the Gm lens group (Gm2) and the imaging plane (IMG).

Detailed design data for the lenses in the lens optical system 100-2, according to this second embodiment, is presented in Table 4. The design data includes the lens's radius of curvature (“Radius”), thickness (“Thick”), refractive power (“nd”), Abbe number (“Vd”), and the lens group to which it belongs. The units for Radius and Thickness are in millimeters.

Furthermore, each lens surface's object is assigned a number (1 to 37 in FIGS. 5 and 6), representing a surface of all lenses arranged in phase (I) from the object (O).

TABLE 4

| Surface | Radius | Thickness | nd | vd | Lens group |
|---|---|---|---|---|---|
| Object | | D0 | | | |
| 1 | 131.7979 | 2.5 | 1.8061 | 33.27 | Group 1 |
| 2 | 78.1984 | 10.1224 | 1.497 | 81.61 | |
| 3 | 1310.745 | 0.1 | | | |
| 4 | 71.2134 | 8.9449 | 1.497 | 81.61 | |
| 5 | 325.675 | D5 | | | |
| 6* | 174.2161 | 0.1 | 1.517 | 52.00 | Group 2 |
| 7 | 93.8089 | 1 | 1.7725 | 49.62 | |
| 8 | 25.4916 | 8.4614 | | | |
| 9 | −156.8284 | 1.0088 | 1.5891 | 61.25 | |
| 10 | 27.4979 | 7.7206 | 1.6889 | 31.16 | |
| 11 | −194.3918 | D11 | | | |
| 12 | −29.7444 | 1 | 1.67 | 47.20 | Group 3 |
| 13 | −147.7181 | 0.1 | | | |
| 14 | 144.045 | 2.9109 | 1.6477 | 33.84 | |
| 15 | −466.5856 | D15 | | | |
| 16 | inf | 1.5 | | | ST (Stop) |
| 17 | 41.9295 | 4.6238 | 1.8697 | 20.02 | Group Gf |
| 18 | 103.5192 | 0.1 | | | |
| 19 | 38.9367 | 6.1859 | 1.5935 | 67.00 | |
| 20 | 498.3902 | 0.124 | | | |
| 21 | 31.0872 | 8.1713 | 1.497 | 81.61 | |
| 22 | −96.5105 | 1 | 2.001 | 29.134 | |
| 23 | 17.2626 | 8.8728 | 1.554 | 71.760 | |
| 24 | 87.2422 | 0.1737 | | | |
| 25* | 29.3088 | 6.6818 | 1.6935 | 53.185 | |
| 26* | −83.0623 | D26 | | | |
| 27 | 69.1446 | 1 | 1.6989 | 30.05 | Group Gm |
| 28 | 24.1589 | D28 | | | |
| 29 | 225.5235 | 4.7166 | 1.8545 | 25.1543 | Group Gr |
| 30 | −53.7141 | 3.6 | | | |
| 31 | −40.8669 | 3.5376 | 1.8545 | 25.1543 | |
| 32 | −28.2668 | 3.2206 | | | |
| 33* | −21.8235 | 1 | 1.7729 | 49.5186 | |
| 34* | −300 | D34 | | | |
| 35 | Inf | 2.5 | 1.5168 | 64.1973 | IMG |
| 36 | Inf | 0.5 | | | |
| 47 | inf | 0 | | | |

Meanwhile, in the lens optical system 100-2 according to the second embodiment depicted in FIGS. 5 and 6, the lens LA2 corresponding to object number 6, the lenses Lf2 with object numbers 25 and 26, and the lenses Lj2 with object numbers 33 and 34 are all aspherical lenses. The specific aspheric coefficient data for the surfaces of these aspherical lenses is presented in Table 5.

TABLE 5

| ASP | 6* | 25* | 26* | 33* | 34* |
|---|---|---|---|---|---|
| K | 1 | 9.0384270 × E−01 | −2.7163000 × E−01 | −1.0687810 × E−01 | −1 |
| A | 2.9771316 × E−06 | −1.5342183 × E−05 | 1.5931854 × E−06 | 1.5486774 × E−06 | −7.4731468 × E−06 |
| B | −1.7729766 × E−09 | −7.6382760 × E−09 | −1.4142348 × E−08 | 3.0613897 × E−08 | 1.9430937 × E−08 |
| C | 2.3920976 × E−12 | −9.6204050 × E−11 | −9.1692567 × E−11 | −4.9177335 × E−11 | −5.1481451 × E−11 |
| D | −2.2053194 × E−16 | 3.7306428 × E−13 | 4.3888223 × E−13 | 5.92527613 × E−14 | 2.9636712 × E−14 |
| E | −1.2125684 × E−18 | −1.2303495 × E−15 | −1.4756537 × E−15 | 0 | 0 |

Furthermore, the zoom data for the lens optical system 100-2 in the second embodiment, considering distances from phase I at infinity and at the closest distance (MOD), is presented in Table 6. In this table, EFL denotes the Effective Focal Length, and BFL (in Air) signifies the distance from the last face of the lens optics to the acquisition element when no filter is positioned in front of the acquisition element. Additionally, Fno indicates the F number, providing insight into the brightness of the lens optics, while FOV represents the size of the area visible to the acquisition element as the field of view. Furthermore, OAL denotes the overall length of the lens optics, measuring the distance from the lens closest to the object side (O) of the lens optics to the imaging plane (IMG). Lastly, D0 to D34 represent the variable distances within the lens optic system 100-2.

TABLE 6
Zoom data Zoom ratio: 4.3

| | Infinity | | | MOD | | |
|---|---|---|---|---|---|---|
| Config | Wide | Middle | Tele | Wide | Middle | Tele |
| EFL | 35 | 70 | 150 | | | |
| BFE | 16.618 | 31.953 | 36.169 | | | |
| (in Air) | | | | | | |
| Fno | 2.08 | 2.71 | 2.85 | | | |
| FOV | 64.2 | 33.9 | 16.1 | | | |
| OAL | 150.838 | 153.795 | 177.809 | | | |
| β | — | — | — | 0.167 | 0.178 | 0.181 |
| D0 | inf | inf | inf | 161.691 | 313.398 | 635.169 |
| D5 | 1.200 | 21.946 | 58.749 | — | — | — |
| D11 | 9.752 | 7.492 | 5.201 | — | — | — |
| D15 | 25.909 | 11.477 | 1.500 | — | — | — |
| D26 | 1.635 | 2.181 | 1.213 | 4.834 | 6.518 | 9.917 |
| D28 | 13.863 | 12.222 | 12.669 | 10.665 | 7.885 | 3.965 |
| D34 | 14.472 | 29.807 | 34.023 | — | — | — |

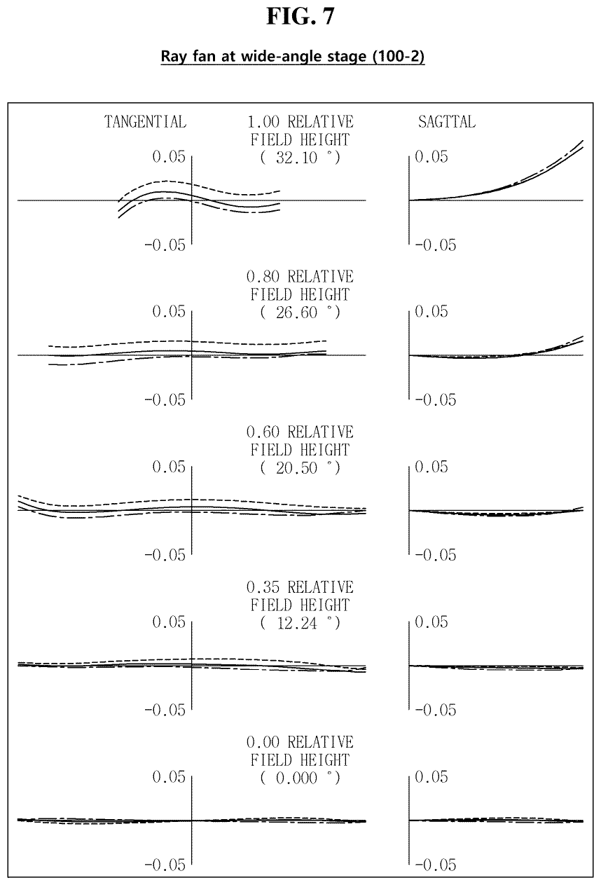

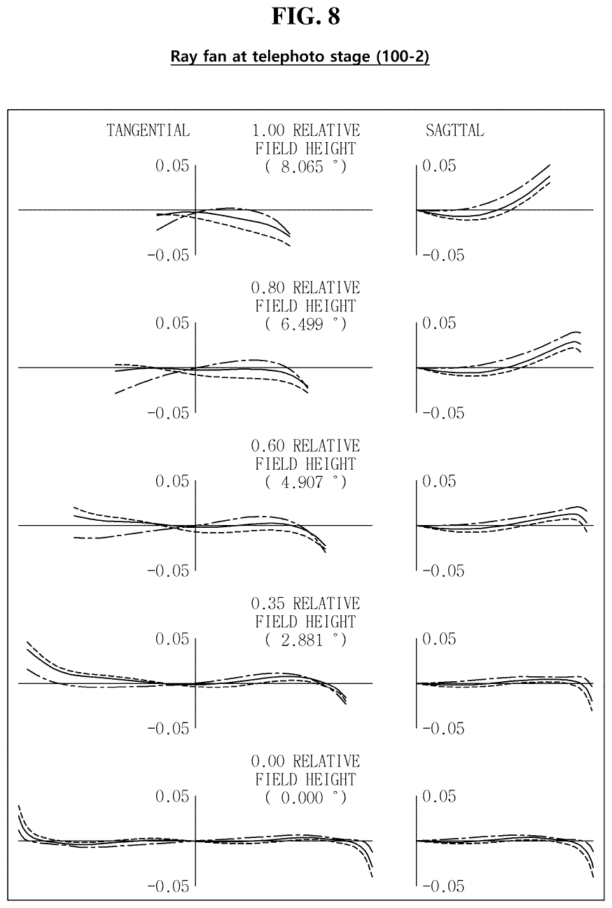

FIG. 7 is a view showing a ray fan diagram of the lens optical system 100-2 at a wide-angle stage, according to the first embodiment of the present invention, and FIG. 8 is a view showing a ray fan diagram of the lens optical system 100-2 at a telephoto stage, according to the first embodiment of the present invention.

Here, a dotted line denotes a 656.2725 NM wavelength (C-line), a solid line denotes a 587.5618 NM wavelength (d-line), and a dashed line denotes a ray fan (unit: mm) for a 486.1327 NM wavelength (F-line).

These ray fans are plotted as a ray fan graph for the respective Tangential and Sagittal planes when the relative field heights are 0 F, 0.35 F, 0.60 F, 0.80 F and 1.00 F.

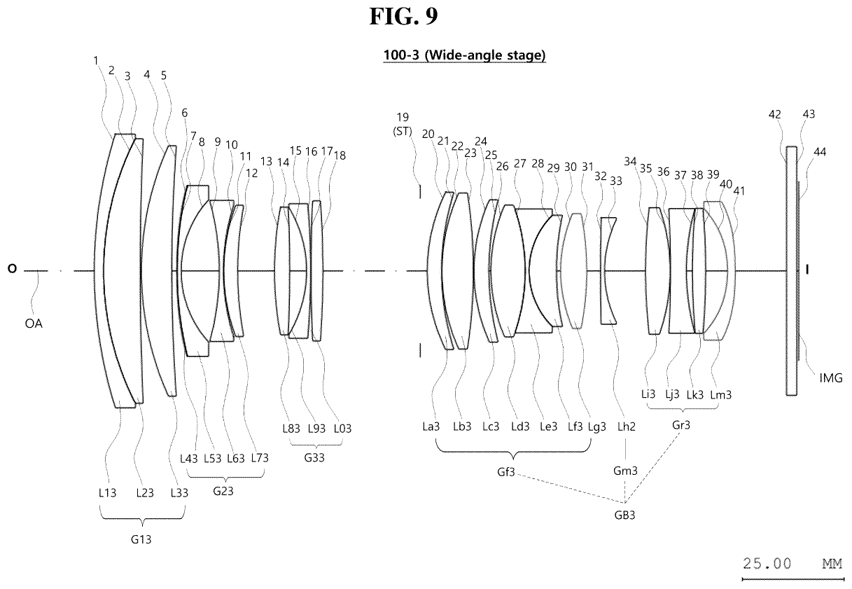

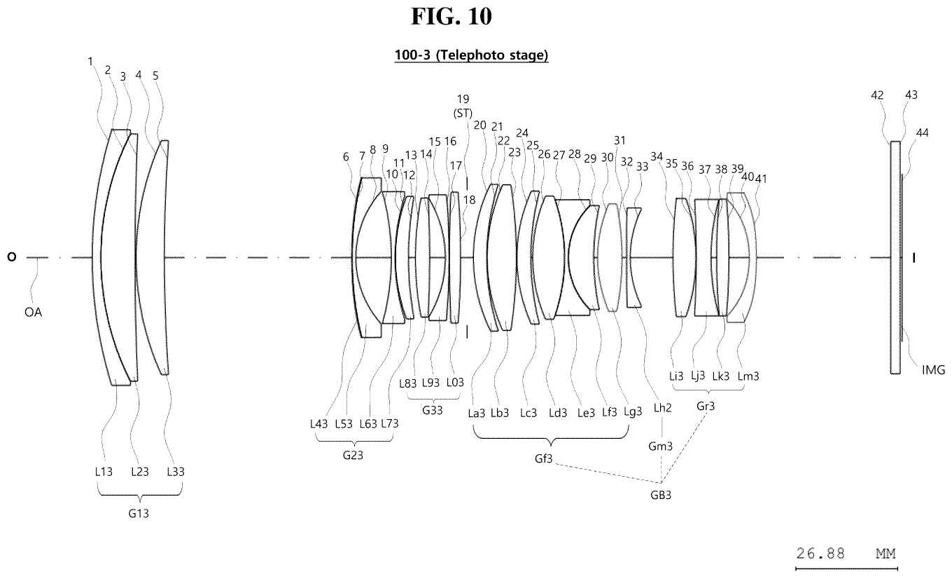

FIG. 9 illustrates an optical layout detailing the arrangement of lens components at a wide-angle stage configuration of a lens optical system 100-3, according to the third embodiment of the present invention, and FIG. 10 illustrates an optical layout detailing the arrangement of lens components at a telephoto stage configuration of the same lens optical system 100-3. In both figures, numbers 1 to 44 denote identification numbers for a lens surface (with two surfaces for one lens), L13 to Lm3 represent lens identification numbers, and G13 to Gr3 represent identification symbols for groups of lenses, respectively.

Referring to FIGS. 9 and 10, the lens optical system 100-3 comprises a front-end lens group consisting of the first lens group G13, second lens group G23, and third lens group G33, arranged sequentially from the object side O to the image side I. Additionally, it includes a rear-end lens group comprising the Gf lens group Gf3, Gm lens group Gm3, and Gr lens group Gr3.

The first lens group G13 includes one double-junction lens L13, L23 and one meniscus lens L33 from the object side O, with a composite focal length having positive refractive power. This design allows subsequent lens groups, including the second lens group (G23) and those following it, to have smaller apertures, contributing to the lightweighting of the lens optics. During changes in magnification, the first lens group G13 moves towards the object side O along the optical axis OA, necessary as the focal point inside the lens optical system must move further towards the object side O than the position of the conventional wide-angle stage, depending on the focal length of the telephoto stage (refer to FIG. 10). Simultaneously, the second lens group G23, featuring a meniscus lens L53 with strong negative refractive power convex to the object side (O), moves towards the image side I along the optical axis OA during magnification changes, executing the primary magnification change action. The third lens group G33 serves as a relay lens between the second lens group G23 and the rear-end lens group GB3.

The rear-end lens group GB3, positioned after the aperture ST concerning the object side O, consists of multiple lens groups Gf3, Gm3, Gr3, wherein the spacing between neighboring lens groups changes during zooming. The entire rear-end lens group GB3 exhibits strong positive refractive power.

Specifically, the rear-end lens group GB3 includes a Gm lens group (Gm3: fifth lens group) moving upwardly (I) along the optical axis (OA) during focusing from an object at an infinite distance to a nearby object. It also comprises a Gf lens group (Gf3: fourth lens group) positioned between the aperture (ST) and the Gm lens group (Gm3), and a Gr lens group (Gr3: sixth lens group) positioned between the Gm lens group (Gm3) and the imaging plane (IMG).

Detailed design data for the lenses in the lens optical system 100-3, according to this third embodiment, is presented in Table 7. The design data includes the lens's radius of curvature (“Radius”), thickness (“Thick”), refractive power (“nd”), Abbe number (“Vd”), and the lens group to which it belongs. The units for Radius and Thickness are in millimeters.

Furthermore, each lens surface's object is assigned a number (1 to 44 in FIGS. 9 and 10), representing a surface of all lenses arranged in phase (I) from the object (O).

TABLE 7

| Surface | Radius | Thickness | nd | vd | Lens group |
|---|---|---|---|---|---|
| Object | | D0 | | | |
| 1 | 107.905 | 2.3 | 1.8061 | 33.27 | Group 1 |
| 2 | 69.35 | 8.98 | 1.497 | 81.61 | |
| 3 | 714.644 | 0.3 | | | |
| 4 | 72.055 | 7.45 | 1.497 | 81.61 | |
| 5 | 408.225 | D5 | | | |
| 6* | 107.572 | 0.1 | 1.517 | 52.00 | Group 2 |
| 7 | 84.704 | 1 | 1.7725 | 49.62 | |
| 8 | 25.193 | 9.356 | | | |
| 9 | −62.158 | 1 | 1.497 | 81.61 | |
| 10 | 51.255 | 0.1 | | | |
| 11 | 44.212 | 3.43 | 1.8061 | 33.27 | |
| 12 | 85.114 | D12 | | | |
| 13 | 81.228 | 3.72 | 1.7174 | 29.50 | Group 3 |
| 14 | −302.602 | 4.13 | | | |
| 15 | −29.21 | 1 | 1.5935 | 67.33 | |
| 16 | −185.808 | 0.1 | | | |
| 17 | 369.447 | 2.93 | 1.8061 | 33.27 | |
| 18 | −231.547 | D18 | | | |
| 19 | inf | 1.7 | | | ST (Stop) |
| 20 | 42.136 | 3.51 | 1.9229 | 20.88 | Group Gf |
| 21 | 60.378 | 0.1 | | | |
| 22 | 45.266 | 7.69 | 1.5182 | 58.960 | |
| 23 | −123.16 | 0.165 | | | |
| 24 | 40.676 | 3.65 | 1.497 | 81.6072 | |
| 25 | 65.291 | 0.5 | | | |
| 26 | 39.135 | 8.4 | 1.497 | 81.6072 | |
| 27 | −45.761 | 1 | 2.001 | 29.1342 | |
| 28 | 18.654 | 6.69 | 1.618 | 63.3949 | |
| 29 | 61.825 | 1.018 | | | |
| 30* | 31.862 | 6.43 | 1.8076 | 40.8841 | |
| 31* | −67.669 | D31 | | | |
| 32 | 500 | 1 | 1.5927 | 35.445 | Group Gm |
| 33 | 28.058 | D33 | | | |
| 34 | 132.345 | 6.02 | 1.8697 | 20.0188 | Group Gr |
| 35 | −45.69 | 0.103 | | | |
| 36 | −265.028 | 3.89 | 1.9229 | 20.88 | |
| 37 | 55.063 | 1.481 | | | |
| 38 | 166.714 | 3.25 | 1.8081 | 22.7639 | |
| 39 | −166.714 | 5.364 | | | |
| 40* | −25.946 | 1.9 | 1.5848 | 58.7091 | |
| 41* | −83.237 | D41 | | | |
| 42 | inf | 2.5 | 1.5168 | 64.1973 | IMG |
| 43 | inf | 0.5031 | | | |
| 44 | inf | −0.0031 | | | |

Meanwhile, in the lens optical system 100-3 according to the third embodiment depicted in FIGS. 9 and 10, the lens LA3 corresponding to object number 6, the lens Lg3 with object numbers 30 and 31, and the lens Lm3 with object numbers 40 and 41 are all aspherical lenses. The specific aspheric coefficient data for the surfaces of these aspherical lenses are presented in Table 8.

TABLE 8

| ASP | 6* | 30* | 31* | 40* | 41* |
|---|---|---|---|---|---|
| K | −2.3031000 × E−02 | 1.2053900 × E−01 | 3.5178070 × E−00 | −2.9594600 × E−01 | 6.7343380 × E−00 |
| A | 2.5797372 × E−06 | −7.2934350 × E−06 | 4.9067293 × E−06 | −3.4369019 × E−05 | −3.4735416 × E−05 |
| B | 8.2727806 × E−10 | 1.0526274 × E−08 | 1.9798820 × E−09 | 1.1581980 × E−07 | 1.3166564 × E−07 |
| C | −2.6988358 × E−12 | −1.4140902 × E−10 | −1.5441265 × E−10 | −3.0168726 × E−10 | −4.3815092 × E−10 |
| D | 4.8379670 × E−15 | 6.7963991 × E−13 | 7.2185395 × E−13 | −2.3770311 × E−13 | 6.8481297 × E−13 |
| E | 1.4902431 × E−18 | −1.5196041 × E−15 | −1.6174730 × E−15 | 1.3924378 × E−15 | −2.9974461 × E−16 |

Furthermore, in the third embodiment, the zoom data for the lens optics 100-3 when the distance from phase I is at infinity and at the closest distance (MOD) is presented in Table 9. In this table, EFL denotes the Effective Focal Length, and BFL (in Air) signifies the distance from the last face of the lens optics to the acquisition element when no filter is positioned in front of the acquisition element. Additionally, Fno refers to the F number, indicating the brightness of the lens optics, while FOV represents the size of the area visible to the acquisition element as the field of view. Furthermore, OAL indicates the overall length of the lens optics, measuring the distance from the lens closest to the object side (O) of the lens optics to the imaging plane (IMG). Lastly, D0 to D41 represent the variable distances within the lens optic system 100-3.

TABLE 9
Zoom data Zoom ratio: 4.1

| | Infinity | | | MOD | | |
|---|---|---|---|---|---|---|
| Config | Wide | Middle | Tele | Wide | Middle | Tele |
| EFL | 35.989 | 73.438 | 146.969 | | | |
| BFE | 14.749 | 29.911 | 37.521 | | | |
| (in Air) | | | | | | |
| Fno | 2.07 | 2.63 | 2.9 | | | |
| FOV | 61.8 | 32.1 | 16.4 | | | |
| OAL | 157.349 | 160.886 | 175.144 | | | |
| β | — | — | — | 0.175 | 0.174 | 0.183 |
| D0 | inf | inf | Inf | 157.000 | 334.990 | 635.000 |
| D5 | 1.200 | 23.041 | 49.374 | — | — | — |
| D12 | 9.037 | 4.826 | 1.849 | — | — | — |
| D18 | 23.915 | 10.809 | 1.700 | — | — | — |
| D31 | 3.373 | 2.868 | 1.195 | 6.792 | 7.233 | 8.764 |
| D33 | 10.067 | 9.585 | 11.269 | 6.648 | 5.220 | 3.700 |
| D41 | 12.602 | 27.764 | 35.374 | — | — | — |

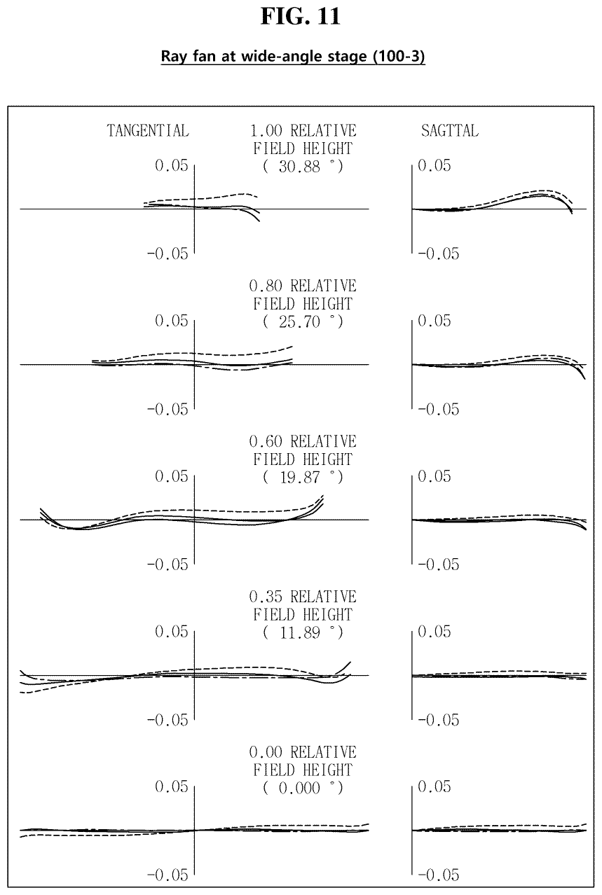

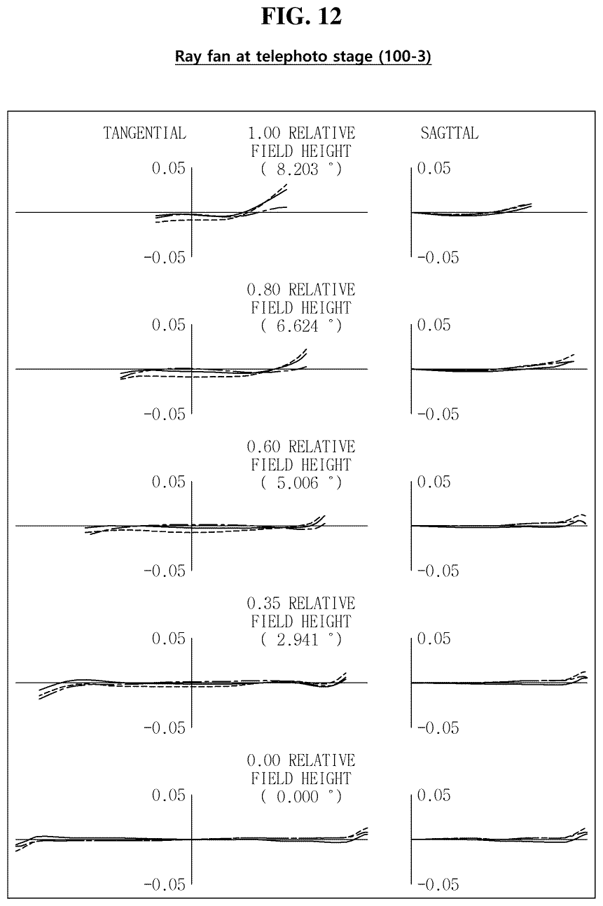

FIG. 11 is a view showing a ray fan diagram of the lens optical system 100-3 at a wide-angle stage, according to the first embodiment of the present invention, and FIG. 12 is a view showing a ray fan diagram of the lens optical system 100-3 at a telephoto stage, according to the first embodiment of the present invention.

Here, a dotted line denotes a 656.2725 NM wavelength (C-line), a solid line denotes a 587.5618 NM wavelength (d-line), and a dashed line denotes a ray fan (unit: mm) for a 486.1327 NM wavelength (F-line).

These ray fans are plotted as a ray fan graph for the respective Tangential and Sagittal planes when the relative field heights are 0 F, 0.35 F, 0.60 F, 0.80 F and 1.00 F.

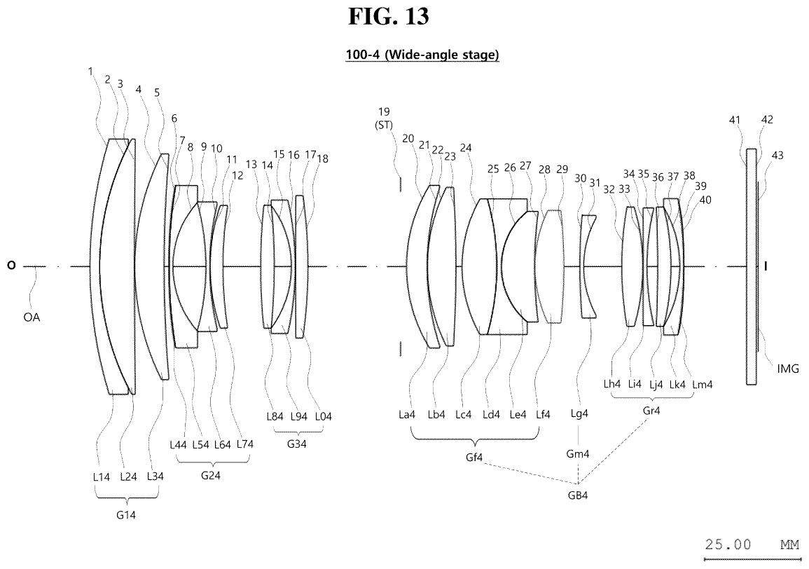

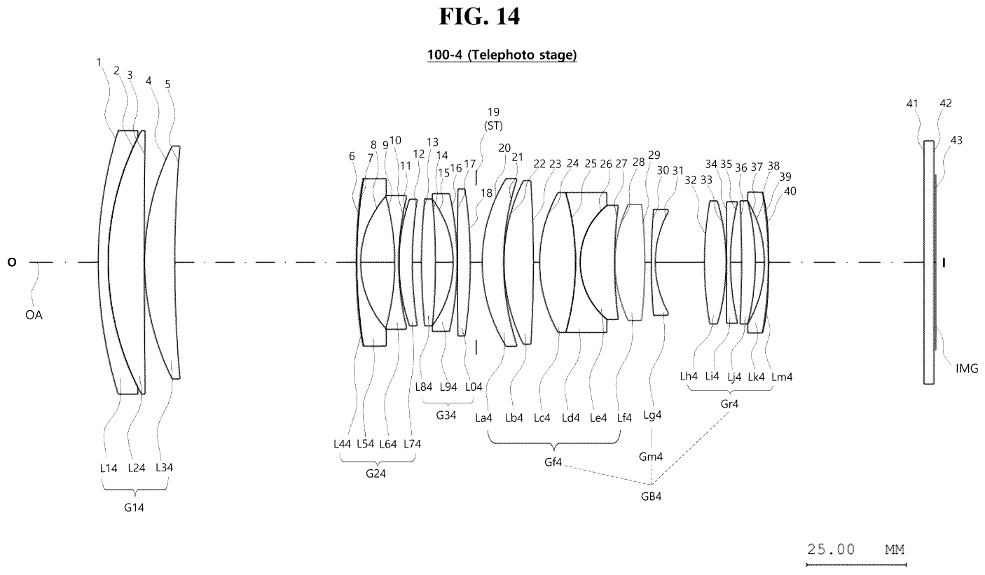

FIG. 13 depicts an optical layout illustrating the arrangement of lens components at a wide-angle stage configuration of a lens optical system 100-4, according to the fourth embodiment of the present invention, and FIG. 14 illustrates an optical layout detailing the arrangement of lens components at a telephoto stage configuration of the same lens optical system 100-4. In both figures, numbers 1 to 43 are identification numbers for a lens surface (with two surfaces for one lens), L14 to Lm4 represent lens identification numbers, and G14 to Gr4 indicate identification symbols for groups of lenses, respectively.

Referring to FIGS. 13 and 14, the lens optical system 100-4 comprises a front-end lens group consisting of the first lens group G14, second lens group G24, and third lens group G34, arranged sequentially from the object side O to the image side I. Additionally, it includes a rear-end lens group comprising the Gf lens group Gf4, Gm lens group Gm4, and Gr lens group Gr4.

The first lens group G14 includes one double junction lens L14, L24 and one meniscus lens L34 from the object side O, with a composite focal length having positive refractive power. This design allows subsequent lens groups, including the second lens group (G24) and those following it, to have smaller apertures, contributing to the lightweighting of the lens optics. During changes in magnification, the first lens group G14 moves along the optical axis OA towards the object side O because the position of the focal point inside the lens optical system must move further towards the object side O than the position of the conventional wide-angle stage, depending on the focal length of the telephoto stage (refer to FIG. 14). Simultaneously, the second lens group G24, featuring a meniscus lens L54 with strong negative refractive power convex to the object side (O), moves towards the image side I along the optical axis OA during magnification changes, executing the primary magnification change action. The third lens group G34 serves as a relay lens between the second lens group G24 and the rear-end lens group GB4.

The rear-end lens group GB4, positioned after the aperture ST concerning the object side O, consists of multiple lens groups Gf4, Gm4, Gr4, wherein the spacing between neighboring lens groups changes during zooming. The entire rear-end lens group GB4 exhibits strong positive refractive power.

Specifically, the rear-end lens group GB4 includes a Gm lens group (Gm4: fifth lens group) moving upwardly (I) along the optical axis (OA) during focusing from an object at an infinite distance to a nearby object. It also comprises a Gf lens group (Gf4: fourth lens group) positioned between the aperture (ST) and the Gm lens group (Gm4), and a Gr lens group (Gr4: sixth lens group) positioned between the Gm lens group (Gm4) and the imaging plane (IMG).

Detailed design data for the lenses in the lens optical system 100-4, according to this fourth embodiment, is presented in Table 10. The design data includes the lens's radius of curvature (“Radius”), thickness (“Thick”), refractive power (“nd”), Abbe number (“Vd”), and the lens group to which it belongs. The units for Radius and Thickness are in millimeters.

Furthermore, each lens surface's object is assigned a number (1 to 43 in FIGS. 13 and 14), representing a surface of all lenses arranged in phase (I) from the object (O).

TABLE 10

| Surface | Radius | Thickness | nd | vd | Lens group |
|---|---|---|---|---|---|
| Object | | D0 | | | |
| 1 | 107.9385 | 2.5 | 1.8061 | 33.27 | Group 1 |
| 2 | 67.6361 | 9.0053 | 1.497 | 81.61 | |
| 3 | 2212.465 | 0.1 | | | |
| 4 | 63.0847 | 7.5762 | 1.497 | 81.61 | |
| 5 | 318.9577 | D5 | | | |
| 6* | 191.7369 | 0.1 | 1.517 | 52.00 | Group 2 |
| 7 | 125.3327 | 1 | 1.7725 | 49.62 | |
| 8 | 24.3326 | 8.5242 | | | |
| 9 | −60.8772 | 1 | 1.5935 | 67.00 | |
| 10 | 66.4827 | 0.1 | | | |
| 11 | 47.817 | 3.3246 | 1.8061 | 33.27 | |
| 12 | 99.436 | D12 | | | |
| 13 | 150.7752 | 3.4955 | 1.7521 | 25.05 | Group 3 |
| 14 | −156.957 | 4.4192 | | | |
| 15 | −26.1305 | 1 | 1.5935 | 67.00 | |
| 16 | −76.5143 | 0.1 | | | |
| 17 | 1689.794 | 3.2245 | 1.8061 | 33.27 | |
| 18 | −124.4005 | D18 | | | |
| 19 | inf | 1.5 | | | ST (Stop) |
| 20 | 38.9524 | 5.3413 | 1.8467 | 23.78 | Group Gf |
| 21 | 64.4194 | 0.1 | | | |
| 22 | 44.3002 | 7.3514 | 1.5935 | 67.001 | |
| 23 | −329.3126 | 1.5797 | | | |
| 24 | 34.4804 | 8.9937 | 1.497 | 81.6074 | |
| 25 | −62.2487 | 1.188 | 2.001 | 29.1342 | |
| 26 | 18.1315 | 8.5973 | 1.5935 | 67.0009 | |
| 27 | 105.1722 | 0.1 | | | |
| 28* | 30.7308 | 7.5 | 1.7729 | 49.5186 | |
| 29* | −114.5681 | D29 | | | |
| 30 | 150.2914 | 1 | 1.5935 | 67.0009 | Group Gm |
| 31 | 25.3538 | D31 | | | |
| 32 | 86.1455 | 5.424 | 1.8467 | 23.7844 | Group Gr |
| 33 | −53.4383 | 0.1 | | | |
| 34 | 4253.278 | 1 | 1.9212 | 23.9557 | |
| 35 | 64.4609 | 2.7656 | | | |
| 36 | −317.1849 | 3.4424 | 1.7282 | 28.32 | |
| 37 | −61.7216 | 2.2705 | | | |
| 38 | −29.7612 | 1 | 1.7725 | 49.6235 | |
| 39 | −102.0736 | 0.1 | 1.517 | 51.9992 | |
| 40* | −177.1527 | D40 | | | |
| 41 | inf | 2.5 | 1.5168 | 64.1973 | IMG |
| 42 | inf | 0.505 | | | |
| 43 | inf | −0.005 | | | |

Meanwhile, in the lens optical system 100-4, according to the fourth embodiment illustrated in FIGS. 13 and 14, the lens LA4 corresponding to object number 6, the lenses Lf4 with object numbers 28 and 29, and the lens LI4 with object number 40 are all aspherical lenses. The specific aspheric coefficient data for the surfaces of these aspherical lenses is provided in Table 11.

TABLE 11

| ASP | 6* | 28* | 29* | 40* |
|---|---|---|---|---|
| K | −1 | 8.3236660 × E−01 | −1 | −1 |
| A | 3.3264412 × E−06 | −8.6104018 × E−06 | 5.7497288 × E−06 | −6.9829614 × E−06 |
| B | −3.0684689 × E−10 | 7.8828852 × E−10 | −4.5428109 × E−09 | −1.3791030 × E−09 |
| C | −1.8288471 × E−12 | −9.3911136 × E−11 | −1.0235595 × E−10 | −8.3877577 × E−12 |
| D | 7.2112287 × E−15 | 3.3753722 × E−13 | 3.8190518 × E−13 | 2.1601086 × E−14 |
| E | −2.5050028 × E−18 | −8.7357854 × E−16 | −9.5458785 × E−16 | −7.0517414 × E−18 |

Furthermore, in the fourth embodiment, the zoom data for the lens optics 100-4, when the distance from phase I is at infinity and at the closest distance (MOD), is presented in Table 12. In this table, EFL denotes the Effective Focal Length, and BFL (in Air) signifies the distance from the last face of the lens optics to the acquisition element when no filter is positioned in front of the acquisition element. Additionally, Fno refers to the F number, indicating the brightness of the lens optics, while FOV represents the size of the area visible to the acquisition element as the field of view. Furthermore, OAL indicates the overall length of the lens optics, measuring the distance from the lens closest to the object side (O) of the lens optics to the imaging plane (IMG). Lastly, D0 to D40 represent the variable distances within the lens optical system 100-4.

TABLE 12
Zoom data Zoom ratio: 4.3

| | Infinity | | | MOD | | |
|---|---|---|---|---|---|---|
| Config | Wide | Middle | Tele | Wide | Middle | Tele |
| EFL | 34.975 | 70 | 149.998 | | | |
| BFE | 18.36 | 35.942 | 41.06 | | | |
| (in Air) | | | | | | |
| Fno | 1.99 | 2.61 | 2.8 | | | |
| FOV | 64.0 | 33.6 | 16.0 | | | |
| OAL | 153.781 | 151.582 | 168.088 | | | |
| β | — | — | — | 0.172 | 0.182 | 0.187 |
| D0 | inf | inf | Inf | 157.004 | 311.622 | 639.998 |
| D5 | 1.200 | 18.046 | 45.504 | — | — | — |
| D12 | 9.777 | 5.460 | 2.300 | — | — | — |
| D18 | 24.004 | 10.945 | 1.500 | — | — | — |
| D29 | 4.128 | 3.632 | 1.631 | 7.566 | 8.066 | 9.996 |
| D31 | 9.850 | 8.675 | 12.329 | 6.412 | 4.242 | 3.965 |
| D40 | 16.214 | 33.796 | 38.914 | — | — | — |

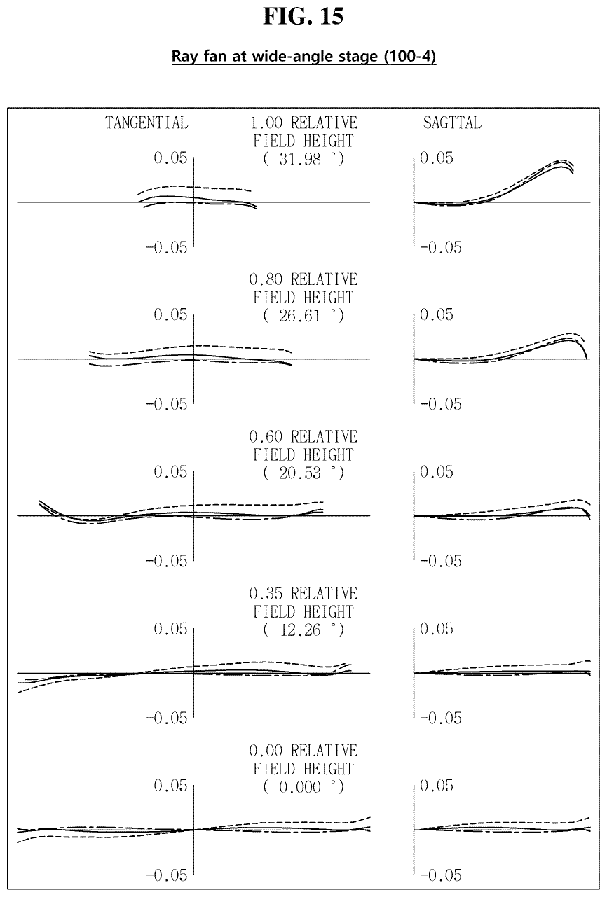

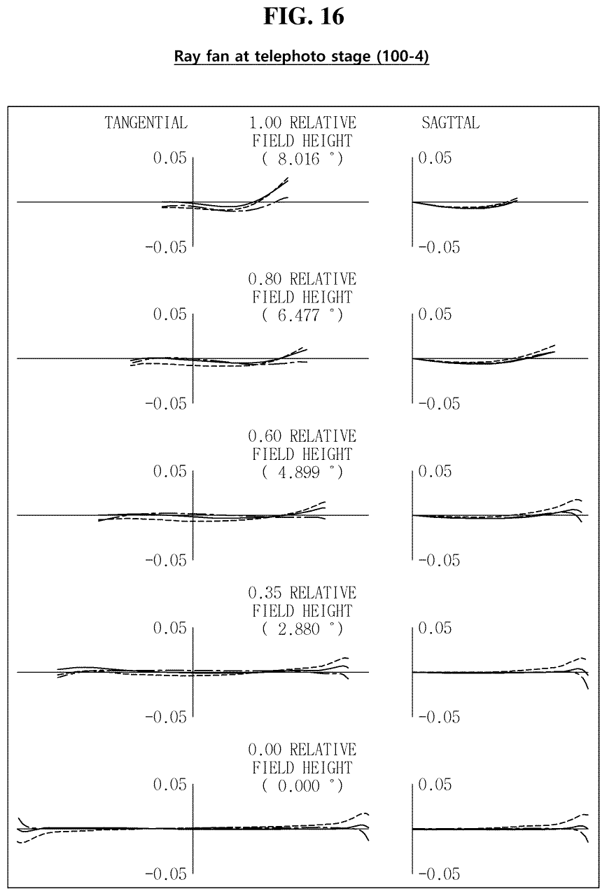

FIG. 15 is a view showing a ray fan diagram of the lens optical system 100-4 at a wide-angle stage, according to the first embodiment of the present invention, and FIG. 16 is a view showing a ray fan diagram of the lens optical system 100-4 at a telephoto stage, according to the first embodiment of the present invention.

Here, a dotted line denotes a 656.2725 NM wavelength (C-line), a solid line denotes a 587.5618 NM wavelength (d-line), and a dashed line denotes a ray fan (unit: mm) for a 486.1327 NM wavelength (F-line).

These ray fans are plotted as a ray fan graph for the respective Tangential and Sagittal planes when the relative field heights are 0 F, 0.35 F, 0.60 F, 0.80 F and 1.00 F.

In each of the four embodiments mentioned above, the optical properties are summarized in Table 13 below. The label “x” is used hereafter to refer to an eighth embodiment.

Here, L_{Gm} represents the distance from the first lens on the object side (O) of the Gf lens group (Gfx) to the first lens of the Gm lens group (Gmx) at the wide-angle stage of the lens optical system (100:100-1, 100-2, 100-3, 100-4). Using the lens optical system 100-1 illustrated in FIG. 1 as an example, L_{Gm} is the distance from the first lens L01 on the object side O of the Gf lens group Gf1 to the first lens Lf1 of the Gm lens group Gm1 at the wide-angle stage of the lens optical system 100-1.

Moreover, L_{f} is the distance from the first lens on the object side (O) of the Gf lens group (Gfx) to the last lens of the lastmost lens group (Grx) at the wide-angle stage of the lens optical system 100. Using the lens optical system 100-1 illustrated in FIG. 1 as an example, L_{f} represents the distance from the first lens L01 on the object side O of the Gf lens group Gf1 to the last lens Lk1 of the lastmost lens group Gr1 at the wide-angle stage of the lens optical system 100-1.

Additionally, L_{d} is the position difference in the direction of the optical axis (OA) at the wide-angle stage of the lens optical system 100, between the position of the Gm lens group (Gmx) when the object distance is infinity and the position of the Gm lens group (Gmx) when the object distance is the closest distance (MOD). LW_{Gm} is the distance from the first lens of the Gf lens group (Gfx) to the first lens of the Gm lens group (Gmx) at the wide-angle stage of the lens optical system when the object distance is infinity.

Moreover, Vd_{G-avg} is the average of the dispersion constants of the lenses with the maximum dispersion constant in the first lens group (G1x), second lens group (G2x), third lens group (G3x), and rear lens group (GBx), respectively. Lastly, nₐ is the reciprocal of the average of the refractive indices of all lenses used in the optical system.

TABLE 13

| optical property | | | | |
|---|---|---|---|---|
| indices | 1^{st} embodiment | 2^{nd} embodiment | 3^{rd} embodiment | 4^{th} embodiment |
| L_{Gm} | 44.6088 | 37.5687 | 42.5260 | 44.8790 |
| L_{f} | 81.7716 | 68.5070 | 75.6010 | 71.8310 |
| L_{d} | 9.3205 | 3.1874 | 3.4189 | 3.4132 |
| LW_{Gm} | 44.6088 | 37.3687 | 42.5260 | 44.8790 |
| Vd_{G-avg} | 81.6100 | 72.8675 | 81.6100 | 74.3050 |
| $\frac{{L}_{G m}}{{L}_{f}}$ | 0.5455 | 0.5484 | 0.5625 | 0.6248 |
| $\frac{L {W}_{G m}}{{L}_{d}}$ | 4.7861 | 11.7471 | 12.4386 | 13.1487 |
| $\frac{1}{{n}_{a}}$ | 0.590 | 0.595 | 0.592 | 0.591 |

For lightweighting of the lens optical system 100 in the aforementioned embodiments, the position of the Gm lens group Gmx, correcting the position of the image point that varies with the object position O, can be determined according to the terms of the following Equation 2.

$$0.52 \leq \frac{{L}_{Gm}}{{L}_{f}} \leq 0.65 \qquad [ Equation 2 ]$$

However, as the rear lens group GBx is situated between the aperture ST and the imaging plane IMG, the aperture of lenses within the rear lens group GBx decreases with the distance from the aperture ST along the principal ray on the optical axis OA, determining the position of the image point. Conversely, as the angle of view increases, the aperture of lenses within the rear lens group (GBx) increases as the principal ray approaches the imaging plane (IMG).

Therefore, by preventing the Gm lens group Gm1, performing focusing, from being too close to either the aperture (ST) or the imaging surface (IMG), it is possible to reduce the weight of the lens optical system 100-1.

Specific gravity is defined as the ratio between the density of a standard material and the density of the target material. Optical glass materials range from FC5 (Hoya corporation) with a specific gravity of 2.5 to E-FDS3 (Hoya corporation) with a specific gravity of 5.6. In general, FDS and BaCD materials of the Dense series, and TaFD, TaF, and TaC materials of the Tantalum series have relatively high specific gravities.

Particularly, tantalum-based materials have a high refractive power, advantageous for simplifying the upper lens optical system and correcting aberrations. When selecting lens optical system materials, their weight can be appropriately considered to achieve lightweighting while minimizing aberrations. In this invention, when selecting lenses for the lens optical system 100, no more than four lenses with a high specific gravity of 3.9 or higher are used to reduce the overall weight of the lens optical system 100.

Chromatic aberration is caused by a difference in the refractive power for a wavelength of light of each lens in the lens optical system, and it can be corrected by an appropriate combination of the refractive power and dispersion constant of the lens optical system as a whole.

Therefore, by using one or more low dispersion lenses in each lens group, from the first lens group (G1x), the second lens group (G2x), the third lens group (G3x) to the rear lens group (GBx), the amount of chromatic aberration generated within each lens group can be reduced, thereby controlling the amount of chromatic aberration generated within each lens group and across the entire lens group.

The following equation 3 calculates the average of the dispersion constants of the low dispersion lenses in each lens group, with a lower bound of 70 indicating the condition for reducing the chromatic aberration generated in each lens group.

$${Vd}_{G - avg} \geq 70 \qquad [ Equation 3 ]$$

On the other hand, for the lens optical system 100 of this invention, to achieve high-speed autofocusing (AF) and simplify the lens optical system, it is necessary to limit the time required for an AF operation from an object that is very far away from the image sensor (infinity) to the closest distance (MOD) allowed by the lens optical system.

If the focusing aberrations are significant, making it difficult to lighten the focusing lens group, the AF operation time can be reduced by directly limiting the amount of movement. However, if the amount of movement for focusing is too small, the precision required to control the driving source increases, leading to increased manufacturing difficulty and decreased focusing accuracy due to the heightened sensitivity of the focusing lens group to movement.

Therefore, it is desirable to limit the movement to satisfy the following Equation 4.

$$4.6 \leq \frac{{LW}_{Gm}}{{L}_{d}} \leq 13.2 \qquad [ Equation 4 ]$$

In Equation 4, the lower limit value of 4.6 is utilized to restrict the overall length of the lens optics 100, ensuring reasonable focusing sensitivity. If a lens optical system falls below this lower limit, the overall length becomes excessively long, making simplification challenging.

Conversely, the upper limit value of 13.2 in Equation 4 is applied to constrain the overall focusing travel. If a lens optical system exceeds this upper limit, the performance change due to focusing becomes too sensitive, necessitating the use of a high-precision drive source.

Equation 5 is employed to limit the magnitude of the Petzval curvature of each lens in the lens optical system 100.

$$\frac{1}{{n}_{a}} \geq 0.59 \qquad [ Equation 5 ]$$

Here, nₐ denotes the average material refractive power of each lens, where a higher refractive power results in a smaller Petzval curvature. However, relying solely on high refractive power materials, as indicated in Equation 2, increases the lens weight, hindering lightweighting and elevating the unit cost of lens materials. Equation 5 is thus employed to effectively suppress the Petzval curvature, achieving overall lightweighting of the lens optical system 100 while maintaining material costs at an appropriate level.

Lens surfaces of each lens in the lens optical system 100 inherently possess a certain degree of reflectivity. These reflections may overlap, creating flare and unnecessary images in the final image, thereby reducing image quality. Typically, the cover glass protecting the imaging element has high reflectivity, and therefore, the flare phenomenon may occur when the last lens in the lens optics system, close to the imaging element (IMG), is flat or concave to the image side (I).

To minimize flare, the image side I needs to be configured as a convex surface to diffuse light reflected from the cover glass. Hence, it is preferable to configure the last lens closest to the image side I of the lastmost lens group (Grx) i.e., the last lens from the object side O, as a meniscus lens which is convex to the image side I.

The lens optical system 100 in this invention reliably compensates for performance changes due to object position while shortening the overall length. Therefore, it is preferable to use aspherical lenses to suppress aberrations due to the shortened length.

As such, when an aspherical surface is used, the closer it is to the first lens surface or the last lens surface of the lens optical system 100, the larger the size of the aspherical surface, which may increase the manufacturing cost. However, in order to improve the correction effect of astigmatism and distortion aberration by the aspherical surface, it is preferable to adopt a lens close to the object side (O) or the image side (I) as an aspherical surface.

Furthermore, it is preferable to adopt an aspherical lens at a position as close as possible to the aperture ST of the lens optical system 100 in order to favor the correction of spherical aberration and chroma aberration. Therefore, the present invention proposes to arrange a total of three aspherical lenses in the second lens group (G2x) and the rear lens group (GBx) in order to efficiently suppress the occurrence of optical aberrations.

In general, junction lenses themselves are somewhat corrected for chromatic aberration and also exhibit adequate power in the overall lens optical system 100, so that they are balanced with the other lenses in the lens optical system and contribute to minimizing chromatic aberration while forming an image. Thus, by arranging a junction lens formed by combining three lenses in the Gf lens group (Gfx) of the lens optical system 100, it is possible to effectively suppress the amount of chromatic aberration generated by the lenses in the rear lens group (GBx).

A resin-bonded aspheric lens or a hybrid aspheric lens, where a resin material is bonded to a spherical lens, is advantageous for aberration control. Placing a single hybrid aspheric lens in the second lens group (G2x) or the rear lens group (GBx) provides effective aberration control while reducing production unit costs compared to conventional glass molding for aspheric lenses.

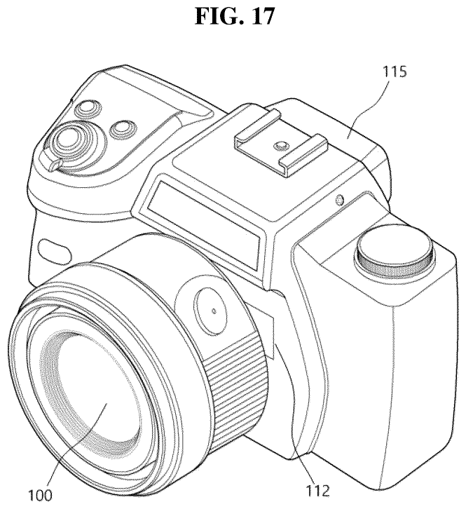

FIG. 17 shows a photographing apparatus having the lens optical system 100 according to the embodiments of the present invention. The lens optical system 100 is substantially the same as the lens systems 100-1, 100-2, 100-3 and 100-4 described with reference to FIGS. 1, 2, 5, 6, 9, 10, 13 and 14. The photographing apparatus may include an image sensor 112 that receives light formed by the lens optical system 100. In addition, it may be provided with a display 115 on which an image of a subject is displayed.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. A lens optical system comprising,
a first lens group closest to an object side with a positive refractive power;
a second lens group located after the first lens group with a negative refractive power;
a third lens group located after the second lens group, consisting of no more than three lenses and having either a positive or negative refractive power; and
a rear lens group next to the third lens group and an aperture, which consists of a multiple lens groups and has a positive refraction power as a whole,
wherein, when zooming from the wide-angle stage to the telephoto stage, the first lens group is moved toward the object side and the second lens group is moved toward an image side, and
wherein the rear lens group includes:
a fifth lens group moving along the optical axis toward the image side when its focusing from an object at an infinite distance to the object at a near distance;
a fourth lens group disposed between the aperture and the fifth lens group; and
a sixth lens group disposed between the fifth lens group and an image plane.

2. The lens optical system of claim 1,
wherein the rear lens group consists of no more than three lenses with a material specific gravity of at least 4.0 and satisfies the condition:
$$0.52 \leq \frac{{L}_{Gm}}{{L}_{f}} \leq 0.65 ,$$
where the L_{f} is the distance from the lens closest to the object side of the fourth lens group to the last lens of the sixth lens group at the wide-angle stage of the lens optical system, and the L_{Gm} is the distance from the lens closest to the object side of the fourth lens group to the first lens of the fifth lens group at the wide-angle stage of the lens optical system.

3. The lens optical system of claim 1,
wherein the lens optical system satisfies the condition:
$${Vd}_{G - avg} \geq 70 ,$$
where the Vd_{G-avg} is the average of the dispersion constants of the lenses with the maximum dispersion constant in each of the first lens group, second lens group, third lens group, and rear lens group.

4. The lens optical system of claim 1,
wherein the lens optical system satisfies the condition:
$$4.6 \leq \frac{{LW}_{Gm}}{{L}_{d}} \leq 13.2 ,$$
where the L_{d} is the position difference in the direction of the optical axis at the wide-angle stage of the lens optical system, between the position of the fifth lens group when the object distance is infinity and the position of the fifth lens group when the object distance is the closest distance, and the LW_{Gm} is the distance from the first lens of the fourth lens group to the first lens of the fifth lens group at the wide-angle stage of the lens optical system when the object distance is infinity.

5. The lens optical system of claim 1,
wherein lens optical system satisfies the condition:
$$\frac{1}{{n}_{a}} \geq 0.59 ,$$
where the nₐ is the reciprocal of the average of the refractive indices for all lenses used in the lens optical system.

6. The lens optical system of claim 1,
wherein the lens of the sixth lens group closest to the image side is a convex meniscus lens convex oriented toward the image side.

7. The lens optical system of claim 1,
wherein the lens optical system comprises three or fewer aspherical lenses.

8. The lens optical system of claim 1,
wherein the fourth lens group comprises a junction lens formed by combining three lenses together.

9. The lens optical system of claim 1,
wherein the second lens group or the rear lens group comprises a single hybrid aspherical lens.
